(19) United States
(12) Patent Application Publication
(10) Pub. No.: US 2025/0110632 A1
(43) Pub. Date: Apr. 3, 2025

(54) TECHNIQUES FOR ADJUSTING AN OUTPUT OF A DEVICE

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US)

(21) Appl. No.: 18/896,449

(22) Filed: Sep. 25, 2024

Related U.S. Application Data
(60) Provisional application No. 63/541,819, filed on Sep. 30, 2023.
(60) Provisional application No. 63/541,813, filed on Sep. 30, 2023.
(60) Provisional application No. 63/541,804, filed on Sep. 30, 2023.

(51) Int. Cl. G06F 3/04847

(52) U.S. Cl. CPC G06F 3/04847

(57) ABSTRACT

The present disclosure generally relates to user interfaces and techniques for adjusting the operation of devices in accordance with some examples, such as controlling the operation of one or more electronic devices based on the value of a setting of the electronic device, adjusting the state of certain types of electronic devices and adjusting the state of one or more electronic devices based on environmental conditions.

### CROSS-REFERENCE TO RELATED APPLICATIONS

This application claims priority to U.S. Provisional Patent Application Ser. No. 63/541,819 entitled “TECHNIQUES FOR ADJUSTING AN OUTPUT OF A DEVICE,” filed Sep. 30, 2023, to U.S. Provisional Patent Application Ser. No. 63/541,813 entitled “USER INTERFACES AND TECHNIQUES FOR CREATING A PERSONALIZED USER EXPERIENCE,” filed Sep. 30, 2023, and to U.S. Provisional Patent Application Ser. No. 63/541,804 entitled “TECHNIQUES FOR CHANGING DISPLAY OF CONTROLS,” filed Sep. 30, 2023, which are hereby incorporated by reference in their entireties for all purposes.

### FIELD

The present disclosure relates generally to computer user interfaces, and more specifically to techniques for adjusting the operation of devices.

### BACKGROUND

Computer systems are often in communication with electronic devices. Computer systems often leverage the communication to control the operation of the electronic devices.

### SUMMARY

Some techniques for adjusting the operation of devices using computer systems, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides computer systems with faster, more efficient methods and interfaces for adjusting the operation of devices. Such methods and interfaces optionally complement or replace other methods for adjusting the operation of devices. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a first device is described. In some embodiments, the method comprises: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a non-transitory computer-readable storage medium storing one or more programs configured to be executed by one or more processors of a computer system that is in communication with a first device is described. In some embodiments, the one or more programs includes instructions for: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a transitory computer-readable storage medium storing one or more programs configured to be executed by one or more processors of a computer system that is in communication with a first device is described. In some embodiments, the one or more programs includes instructions for: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a computer system that is in communication with a first device is described. In some embodiments, the computer system comprises one or more processors and memory storing one or more programs configured to be executed by the one or more processors. In some embodiments, the one or more programs includes instructions for: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a computer system that is in communication with a first device is described. In some embodiments, the computer system comprises means for performing each of the following steps: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a computer program product is described. In some embodiments, the computer program product comprises one or more programs configured to be executed by one or more processors of a computer system that is in communication with a first device. In some embodiments, the one or more programs include instructions for: while a first setting corresponding to the first device is set to a first value, causing the first device to provide first output corresponding to the first value; while causing the first device to provide first output corresponding to the first value, detecting a change in the physical environment; and in response to detecting the change in the physical environment: in accordance with a determination that the first value is within a first range of values for the first setting, causing the first device to provide second output corresponding to a first offset of the first value, wherein the first offset is computed based on the first value being within the first range of values for the first setting; and in accordance with a determination that the first value is within a second range of values for the first setting that is different from the first range of values for the first setting, causing the first device to provide third output corresponding to a second offset of the first value, wherein the second offset is computed based on the first value being within the second range of values for the first setting, wherein the second output is different from the third output, and wherein the second output and the third output are not one or more of a non-zero minimum output and a maximum output.

In some embodiments, a method that is performed at a computer system that is in communication with a first device is described. In some embodiments, the method comprises: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment and that the first device is a second type of device that is different from the first type of device: forgoing causing the offset of the first value to be adjusted; and continuing to cause the first device to provide first output corresponding to the offset of the first value.

In some embodiments, a non-transitory computer-readable storage medium storing one or more programs configured to be executed by one or more processors of a computer system that is in communication with a first device is described. In some embodiments, the one or more programs includes instructions for: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment and that the first device is a second type of device that is different from the first type of device: forgoing causing the offset of the first value to be adjusted; and continuing to cause the first device to provide first output corresponding to the offset of the first value.

In some embodiments, a transitory computer-readable storage medium storing one or more programs configured to be executed by one or more processors of a computer system that is in communication with a first device is described. In some embodiments, the one or more programs includes instructions for: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment and that the first device is a second type of device that is different from the first type of device: forgoing causing the offset of the first value to be adjusted; and continuing to cause the first device to provide first output corresponding to the offset of the first value.

In some embodiments, a computer system that is in communication with a first device is described. In some embodiments, the computer system comprises one or more processors and memory storing one or more programs configured to be executed by the one or more processors. In some embodiments, the one or more programs includes instructions for: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment and that the first device is a second type of device that is different from the first type of device: forgoing causing the offset of the first value to be adjusted; and continuing to cause the first device to provide first output corresponding to the offset of the first value.

In some embodiments, a computer system that is in communication with a first device is described. In some embodiments, the computer system comprises means for performing each of the following steps: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment and that the first device is a second type of device that is different from the first type of device: forgoing causing the offset of the first value to be adjusted; and continuing to cause the first device to provide first output corresponding to the offset of the first value.

In some embodiments, a computer program product is described. In some embodiments, the computer program product comprises one or more programs configured to be executed by one or more processors of a computer system that is in communication with a first device. In some embodiments, the one or more programs include instructions for: while a first setting corresponding to the first device is set to a first value, causing the first device to provide first output corresponding to an offset of the first value; while causing the first device to provide first output corresponding to the first value, detecting a change to a first characteristic in the physical environment; and in response to detecting the change to the first characteristic of the physical environment: in accordance with a determination that output of the first device impacts the first characteristic of the physical environment and that the first device is a first type of device: causing the offset of the first value to be adjusted; and causing the first device to provide output corresponding to the adjusted offset of the first value; and in accordance with a determination that output of the first device impacts the first characteristic of the physical environment that the first device is a second type of device that is different from the first type of device: forgoing causing the offset of the first value to be adjusted; and continuing to cause the first device to provide first output corresponding to the offset of the first value.

In some embodiments, a method that is performed at a computer system that is in communication with a first device and a second device is described. In some embodiments, the method comprises: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

In some embodiments, a non-transitory computer-readable storage medium storing one or more programs configured to be executed by one or more processors of a computer system that is in communication with a first device and a second device is described. In some embodiments, the one or more programs includes instructions for: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

In some embodiments, a transitory computer-readable storage medium storing one or more programs configured to be executed by one or more processors of a computer system that is in communication with a first device and a second device is described. In some embodiments, the one or more programs includes instructions for: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

In some embodiments, a computer system that is in communication with a first device and a second device is described. In some embodiments, the computer system comprises one or more processors and memory storing one or more programs configured to be executed by the one or more processors. In some embodiments, the one or more programs includes instructions for: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

In some embodiments, a computer system that is in communication with a first device and a second device is described. In some embodiments, the computer system comprises means for performing each of the following steps: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

In some embodiments, a computer program product is described. In some embodiments, the computer program product comprises one or more programs configured to be executed by one or more processors of a computer system that is in communication with a first device and a second device. In some embodiments, the one or more programs include instructions for: while the first device corresponds to a first area and the second device corresponds to a second area that is different from the first area, detecting a change in an orientation of a light source relative to a respective object; and in response to detecting the change in orientation of the light source relative to the respective object: in accordance with a determination that the changed orientation of the light source relative to the respective object is a first orientation, causing a characteristic of the first device to be adjusted in a first manner without causing the characteristic of the second device to be adjusted in the first manner; and in accordance with a determination that the changed orientation of the light source relative to the respective object is a second orientation different from the first orientation, causing the characteristic of the second device to be adjusted in the first manner without causing the characteristic of the first device to be adjusted in the first manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for adjusting the operation of devices, thereby increasing the effectiveness, efficiency, and user satisfaction with such devices. Such methods and interfaces may complement or replace other methods for adjusting the operation of devices.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2F illustrate exemplary user interfaces for controlling the operation of one or more electronic devices in accordance with some examples.

FIG. 3 is a flow diagram illustrating a method for controlling the operation of one or more electronic devices based on the value of a setting of the electronic device in accordance with some examples.

FIGS. 4A-4B is a flow diagram illustrating a method for adjusting the state of certain types of electronic devices in accordance with some examples.

FIGS. 5A-5B illustrate exemplary user interface for adjusting the state of one or more electronic devices based on environmental conditions in accordance with some examples.

FIG. 6 is a flow diagram illustrating a method for adjusting the state of one or more electronic devices based on environmental conditions in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for computer systems that provide efficient methods and interfaces for adjusting the operation of devices. For example, the operation of devices can be changed based on a current setting of the device, based on the device type, and/or environmental factors. Such techniques can reduce the cognitive burden on a user who adjusts the operation of devices, thereby enhancing productivity. Further, such techniques can reduce processor and battery power otherwise wasted on redundant user inputs.

The following description sets forth exemplary techniques for adjusting the operation of devices. This description is not intended to limit the scope of this disclosure but is instead provided as a description of example implementations.

Users need electronic devices that provide effective techniques for adjusting the operation of devices. Efficient techniques can reduce a user's mental load when adjusting the operation of devices. This reduction in mental load can enhance user productivity and make the device easier to use. In some embodiments, the techniques described herein can reduce battery usage and processing time (e.g., by providing user interfaces that require fewer user inputs to operate).

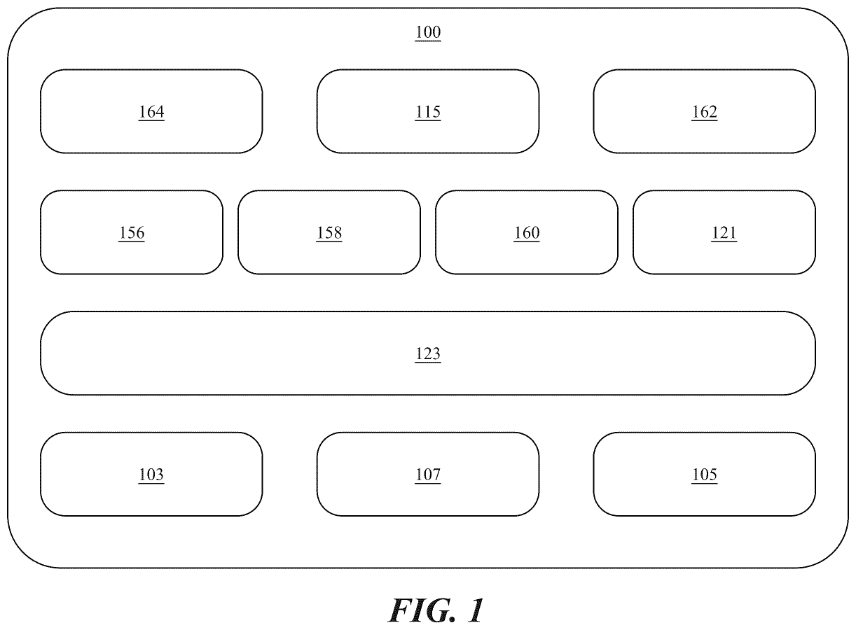

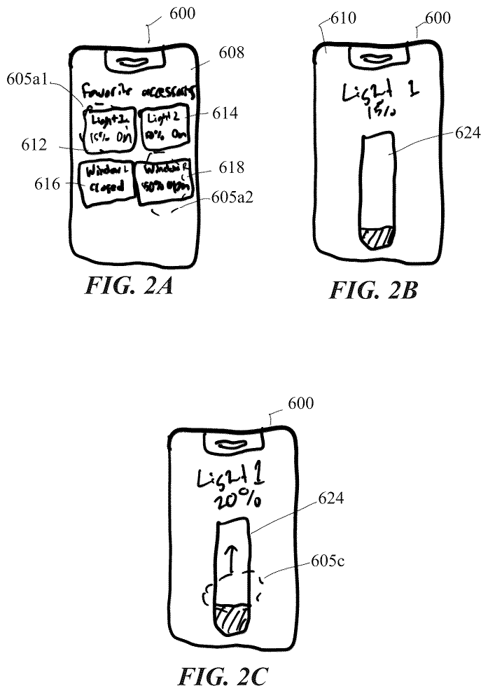

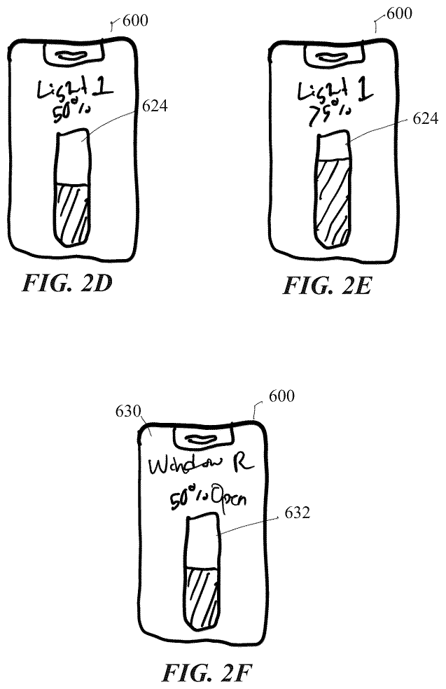

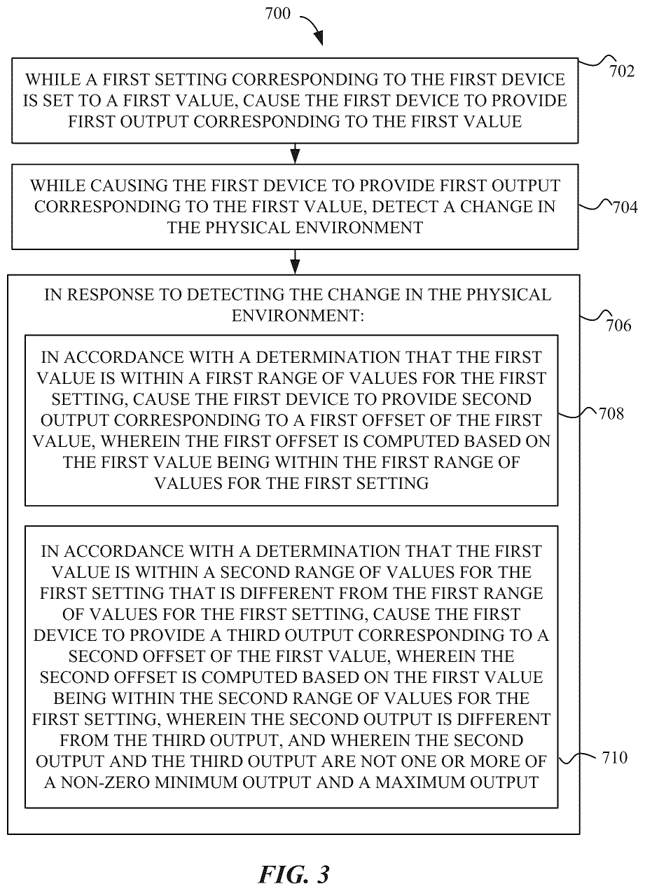

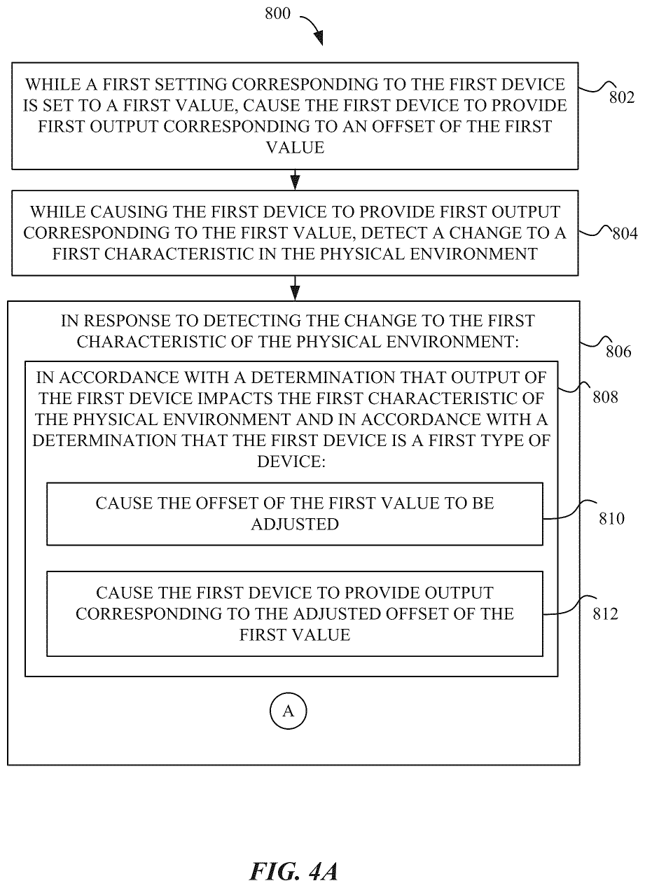

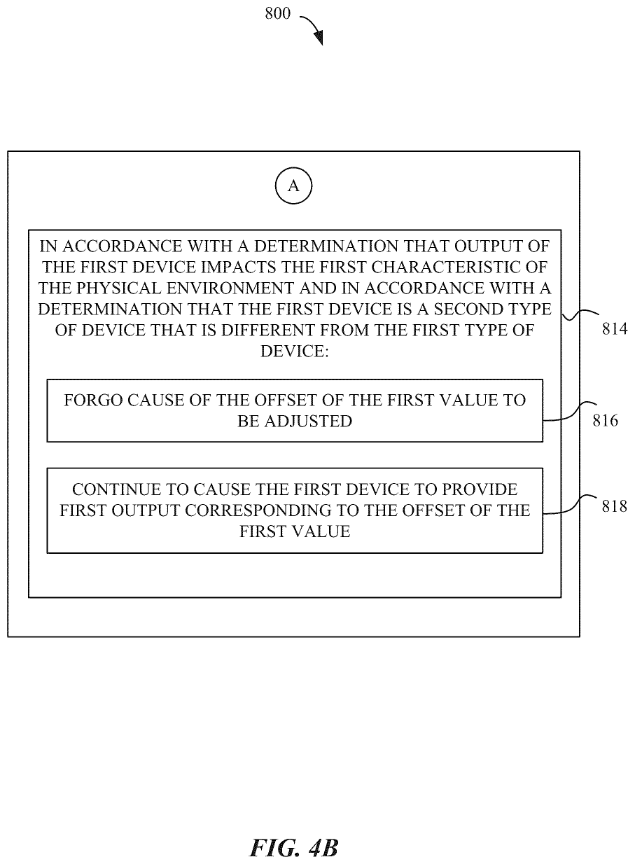

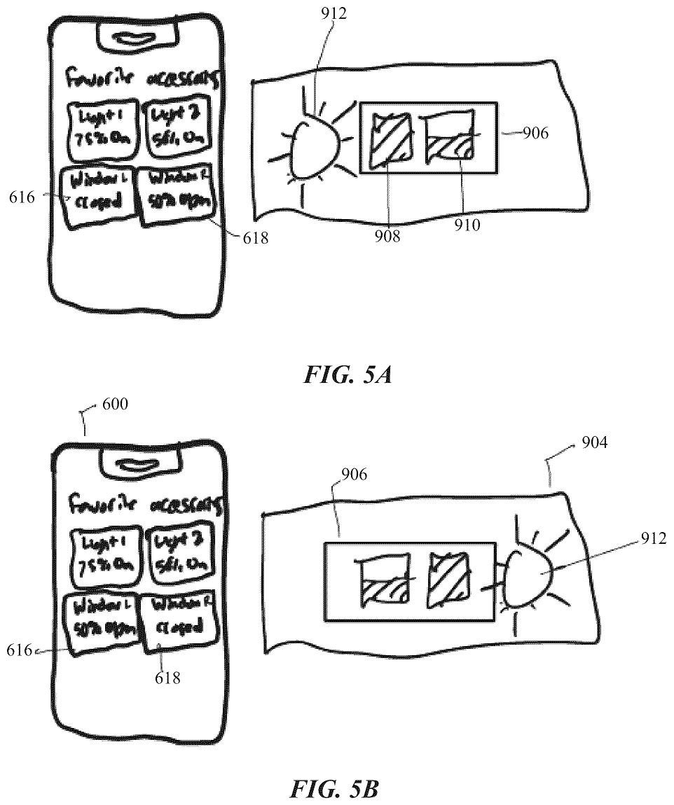

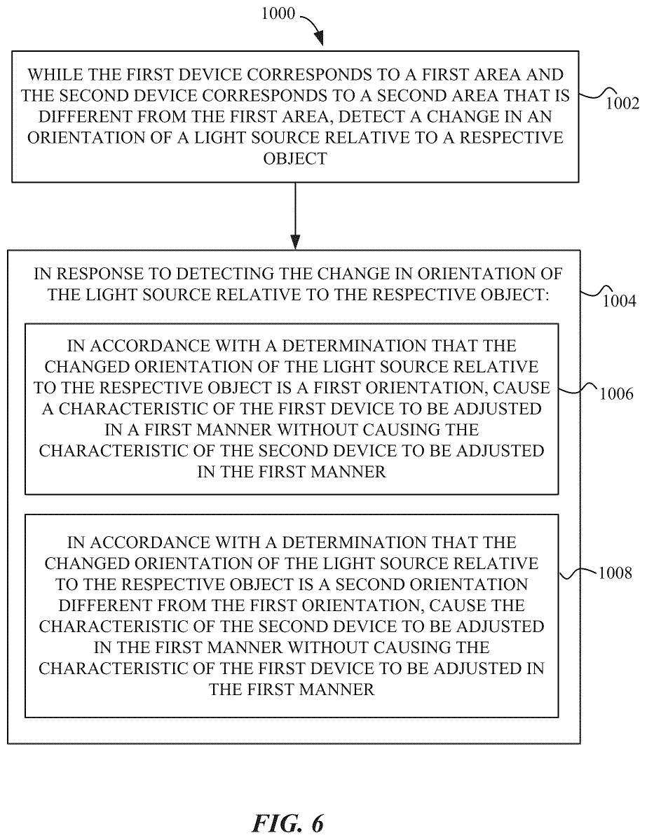

FIG. 1 provides illustrations of exemplary devices for performing techniques for adjusting the operation of devices. FIGS. 2A-2F illustrate exemplary user interfaces for controlling the operation of one or more electronic devices in accordance with some examples. FIG. 3 is a flow diagram illustrating methods of adjusting the operation of one or more electronic devices based on the value of a setting of the electronic device in accordance with some embodiments. FIGS. 4A-4B is a flow diagram illustrating methods of adjusting the state of certain types of electronic devices. The user interfaces in FIGS. 2A-2F are used to illustrate the processes described below, including the processes in FIG. 3 and FIGS. 4A-4B. FIGS. 5A-5B illustrate exemplary user interfaces for adjusting the state of one or more electronic devices based on environmental conditions in accordance with some embodiments. FIG. 6 is a flow diagram illustrating methods of adjusting the state of one or more electronic devices based on environmental conditions in accordance with some examples. The user interfaces in FIGS. 5A-5B are used to illustrate the processes described below, including the processes in FIG. 6.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 4, and/or 6 (e.g., processes 700, 800, and/or 1000) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards examples of user interfaces (“UI”) and associated processes that are implemented on a computer system, such as system 100.

FIGS. 2A-2F illustrate exemplary user interfaces for controlling the operation of one or more electronic device in accordance with some examples. The user interfaces in these figures are used to illustrate the processes described below, including the processes in FIGS. 3 and 4A-4B.

FIG. 2A illustrates computer system 600 (e.g., a smartphone) including display 604 (e.g., a display component). At FIG. 2A, computer system 600 is positioned within an external structure (e.g., a home, a trailer, a boat, an airplane, a smart house, a smart car, a smart boat, and/or a car). In some embodiments, display 604 is a touch-sensitive display. In some embodiments, display 604 is a voice-activated or gesture-enabled display. In some embodiments, computer system 600 includes a knob, a dial, a joystick, a touch-sensitive surface, a button, and/or a slider. In some embodiments, computer system 600 is a television, a projector, a monitor, a smart display, a laptop, and/or a personal computer. In some embodiments, computer system 600 includes one or more components of system 100 described above.

As illustrated in FIG. 2A, computer system 600 displays controls user interface 608 Controls user interface 608 includes first light control user interface object 612, second light control user interface object 614, first window control user interface object 616, and second window control user interface object 618. First light control user interface object 612 corresponds to (e.g., is configured to control and/or is a user interface object for controlling) a first light device, second light control user interface object 614 corresponds to a second light device, first window control user interface object 616 corresponds to a first window, and second window control user interface object 618 corresponds to a second window. Each of the first light, second light, first window, and second window are positioned within the external structure. For example, controls user interface 608 could be an interface for a smart house that includes two lights and two windows in a room of the house. It should be understood that types of computer systems, user interfaces objects, user interfaces, and/or components described herein are merely exemplary and are provided to give context to the embodiments described herein.

Computer system 600 is in communication (e.g., wireless and/or wired communication (e.g., Bluetooth, Wi-Fi, and/or Ultra-Wideband)) with each of the first light, second light, first window, and second window. In some embodiments, computer system 600 transmits one or more instructions to a respective device that causes a respective device (e.g., the first light, the second light, the first window, and/or the second window) to operate differently in response to detecting an input (e.g., a tap input, swipe input, rotation of a rotatable input device, gaze, voice command and/or hand gesture) that corresponds to selection of a respective control user interface object (e.g., first light control user interface object 612, second light control user interface object 614, first window control user interface object 616, and second window control user interface object 618).

Each of the first light device, second light device, first window, and second window are local devices. Local devices are devices within the external structure whose operation impacts a portion of the external structure (e.g., not the entirety of the external structure) (e.g., the first light device illuminates a first area of the external structure). The external structure also includes global devices. Global devices are devices within the external structure whose operation impacts the entire external structure (e.g., an air conditioning device that heats and/or cools the entire external structure). Each of first light control user interface object 612, second light control user interface object 614, first window control user interface object 616, and second window control user interface object 618 are local controls. Local controls are configured to control the operation of local devices that are positioned in a particular area of the physical structure.

As illustrated in FIG. 2A, each of first light control user interface object 612, second light control user interface object 614, first window control user interface object 616, and second window control user interface object 618 include an indication of the status of the accessory that corresponds to the respective control user interface object. That is, first light control user interface object 612 indicates that the first light device is operating at 15% power, second light control user interface object 614 indicates that the second light device is operating at 50% power, first window control user interface object 616 indicates that the first window is closed, and second window control user interface object 618 indicates that the second window halfway open. In some embodiments, computer system 600 updates, in real-time, the status indicator included in first light control user interface object 620, second light control user interface object 622, first window control user interface object 616, and/or second window control user interface object 619 based on a determination being made that the operation of the corresponding accessory changes. While described above as each user interface object (e.g., in controls user interface 608) corresponding to a single accessory device and a single setting, it should be recognized that a user interface object can correspond to one or more accessory devices and/or one or more settings for a single accessory device and that different user interface objects can correspond to different settings (e.g., brightness and hue) for a single accessory device (e.g., a light).

At FIG. 2A, computer system 600 detects inputs 605al that corresponds to selection of first light control user interface object 612 or computer system 600 detects input 605a2 that corresponds to selection of second window control user interface object 618. In some embodiments, input 605al and/or input 605a2 corresponds to a tap input, swipe input, voice command, long press (e.g., tap and hold), a rotational input, a swipe input, an air gesture, a gaze input and/or hand gesture. In some embodiments, other inputs described below in relation to FIGS. 2A-2F can alternatively be one or more other types of inputs, such as a rotational input, a swipe input, a tap input, an air gesture, a voice input, and/or a gaze input.

As illustrated in FIG. 2B, in response to detecting input 605a1, computer system 600 displays first light user interface 610. As illustrated in FIG. 2B, first light user interface 610 includes brightness control user interface object 624. Computer system 600 displays a portion of brightness control user interface object 624 as filled in based on the brightness level of the first light device. At FIG. 2B, the first light device is operating at a 15% brightness level. Accordingly, as illustrated in FIG. 2B, computer system 600 displays 15% of brightness control user interface object 624 as filled in.

At FIG. 2B, the first light device and the brightness level of the physical environment (e.g., the physical environment within the external structure or outside of the external structure) have a first relative brightness level relationship (e.g., the physical environment is 1.5, 2, or 3 times brighter/darker than the brightness of the fight light device and/or the first light device and the brightness of the physical environment are within a same brightness category (e.g., below average brightness, average brightness, or above average brightness)). In some embodiments, computer system 600 ceases to display first light user interface 610 and displays controls user interface 608 in response to detecting an input. While described above as first light user interface 610 corresponding to a single accessory device and a single setting, it should be recognized that first light user interface 610 can correspond to one or more accessory devices (e.g., and include separate controls for each of the one or more accessory devices) and/or one or more settings (e.g., and include separate controls for each of the one or more settings) for a single accessory device.

At FIG. 2C, a determination is made that the brightness level of the physical environment decreases by a first amount (e.g., in contrast to the brightness level of the physical environment at FIG. 2B). At FIG. 2C, because a determination is made that the brightness level of the physical environment decreases, computer system 600 transmits one or more instructions to the first light device that cause the brightness of the first light device to increase from a 15% brightness level to a 20% brightness level. That is, the one or more instructions cause the brightness level of first light device to increase by a first offset value of five percent. Computer system 600 causes the first light device to increase its brightness level to help offset the decrease in the brightness level of the physical environment. In some embodiments, the increase in the brightness level of the first light device maintains the relative brightness level relationship between the first light device and the physical environment. In some embodiments, the relative brightness level relationship between the first light device and the physical environment is not maintained after the brightness level of the first light device is increased.

Computer system 600 adjusts the brightness level of the first light device based on the detected change of the brightness of the physical environment and the current brightness setting of the first light device. The offset value is based on the detected changes to the brightness level of the physical environments and the setting of the first light device at the time the change in the brightness of the physical environment is detected. The offset value is smaller the closer the brightness setting of the first light device is to a maximum or minimum brightness setting of the first light device at the time the change in the brightness of the physical environment is detected. In contrast, the offset value is greater the closer the brightness setting of the first light device is to an average value of the maximum brightness setting and the minimum brightness setting of the first light device at the time the change in the brightness of the physical environment is detected. In some embodiments, based on a determination being made that one or more characteristics of the physical environment change, computer system 600 transmits one or more instructions to local devices of the external structure that adjust the operation and/or position of the local devices and computer system 600 does not transmit one or more instructions to global devices of the external structure or vice versa. In some embodiments, based on a determination being made that one or more characteristics of the physical environment change, computer system 600 transmits one or more instructions to the global devices and local devices of the external structure that adjust the operation and/or position of the global devices and local devices. In some embodiments, computer system 600 transmits one or more instructions to a first one or more devices of the external structure based on a determination being made that the environment within computer system 600 (e.g., within the housing of computer system 600 and/or within a space that computer system 600 occupies) changes and computer system 600 does not transmit one or more instructions to a second set one or more devices of the external structure based on a determination being made that the environment within computer system 600 changes. In some embodiments, computer system 600 causes the brightness of the first light device to be adjusted by an amount that is less than or equal to (e.g., but not more than) the first offset amount. In some embodiments, the offset value is based on at least the setting of the type of device that computer system 600 adjusts (e.g., a default offset value for an air conditioning device is larger or smaller than a default offset value for a playback device). In some embodiments, computer system 600 adjusts brightness level and/or color of the first light device based on brightness and/or color of light in the physical environment. For example, computer system 600 can adjust light of the first light device to match and/or offset (e.g., to make a color defined by a user of computer system 600 and/or a predefined color) color of the physical environment (e.g., reduce brightness when the physical environment is brighter and/or output offsetting color when the physical environment is a different color than normal, such as orange or red due to weather).

At FIG. 2C, because the brightness level of the first light device increases from 15% to 20%, computer system 600 updates the display of brightness control user interface object 624 to indicate the new brightness level of the first light device. Accordingly, as illustrated in FIG. 2C, computer system 600 displays brightness control user interface object 624 as 20% filled in. At FIG. 2C, computer system 600 detects input 605c that corresponds to selection of brightness control user interface object 624. In some embodiments, input 605c corresponds to a tap input, swipe input, voice command, long press (e.g., tap and hold), and/or air hand gesture. In some embodiments, computer system 600 adjusts the playback (e.g., adjust the volume, initiates playback, pauses playback, or ceases playback) of one or more playback devices within the external structure based on a determination being made that a sound level of the physical environment increases or decreases. In some embodiments, computer system 600 adjusts the operation of an air conditioning device (e.g., a device capable of heating and/or cooling a space) within the external structure based on a determination being made that the temperature of the physical environment increases or decreases. In some embodiments, computer system 600 changes the positioning (e.g., opens or closes) a window of the external structure based on a determination being made that one or more characteristics (e.g., temperature, brightness, amount of sun, wind, noise, and/or precipitation) of the physical environment change.

At FIG. 2D, in response to detecting input 605c, computer system 600 transmits one or more instructions to the first light device that cause the brightness level of the first light device to increase from 20% to 50%. As illustrated in FIG. 2D, because the first light device operates at a 50% brightness level, computer system 600 displays brightness control user interface object 624 as halfway filled.

At FIG. 2E, a determination is made that the brightness level of the physical environment decreases by the first amount (e.g., in contrast to the brightness level of the physical environment at FIG. 2D). That is, at FIGS. 2C and 2E, the brightness level of the physical environment decreases by the same amount. At FIG. 2E, because a determination is made that the brightness level of the physical environment decreases by the first amount, computer system 600 transmits one or more instructions to the first light device that increase the brightness level of the first light device from 50% to 75%. That is, the one or more instructions cause the brightness level of first light device to increase by a second offset value of 25%. Even though the brightness level of the physical environment decreases by the same amount as it did at FIG. 2C, computer system 600 adjusts the brightness level of the first light device by a greater magnitude (e.g., 25%) than the adjustment of the brightness level of the first device at FIG. 2C.

As explained above, computer system 600 adjusts the brightness level of the first light device by a smaller magnitude the closer the brightness setting of the first light device is to a maximum or minimum brightness setting of the first light device than when the brightness setting of the first light device is closer to an average of the maximum and minimum brightness setting of the first light device. At FIG. 2C, before the brightness level of the first light device is adjusted, the brightness level of the first light device is proximate to the minimum brightness level of first device. In contrast, at FIG. 2E, before the brightness level of the first light device is adjusted, the brightness level of the first light device is at the average of the maximum brightness level and the minimum brightness level of the first light device. Accordingly, at FIG. 2E, computer system 600 adjusts the brightness level of the first light device by the second offset value that is greater than the first offset value.

As illustrated in FIG. 2F, in response to detecting input 605a2 (e.g., as shown in FIG. 2A), computer system 600 displays second window control user interface 630. As illustrated in FIG. 2F, second window control user interface 630 includes window control user interface object 632. Computer system 600 displays a portion of window control user interface object 632 as filled in based on the positioning of the second window. At FIG. 2F, the second window of the external structure is halfway open. Accordingly, as illustrated in FIG. 2F, computer system 600 displays half of window control user interface object 632 as filled in. In some embodiments, computer system 600 updates the display of brightness control user interface object 624, in real time, based on changes to the brightness level of the first device and computer system 600 does not update the display of window control user interface object 632, in real time, based on changes to the positioning of the first window device or vice versa.

At FIG. 2F, a determination is made that the brightness of the physical environment decreases by the first amount (e.g., in comparison to the brightness level of the physical environment at FIG. 2A). At FIG. 2F, computer system 600 does not transmit one or more instructions to the second window in accordance with the determination that the brightness of the physical environment decreases by the first amount. That is, computer system 600 only adjusts the operation/position of certain types of devices within the external structure based on detected changes to a respective characteristic (e.g., changes to the brightness level of the physical environment) of the physical environment).

At FIG. 2F, because the operation and/or position of the second window does not change, computer system 600 does not update the display of window control user interface object 632. In some embodiments, based on a determination being made that one or more characteristics of the physical environment change, computer system 600 transmits one or more instructions to a first device that performs a first type of operation (e.g., heats a space) that modify the operation of the first type of device and computer system 600 does not transmit one or more instructions to a second type of device that performs a second operation (e.g., cools a space) that is opposite the first type of operation. In some embodiments, based on a determination being made that one or more characteristics of the physical environment change, computer system 600 transmits one or more instructions to the first and second window of the physical structure that adjust the positioning of the first and second window and computer system 600 does not transmit one or more instructions to the first and second light devices of the external structure. In some embodiments, based on a determination being made that the brightness in the environment increase, computer system 600 transmits one or more instructions to the first and second window of the physical structure that cause the first and/or second window to lower and computer system 600 transmits one or more instructions to the first and/or second light devices that cause the brightness level of the first and/or second window to decrease. In some embodiments, based on a determination being made that the brightness of the physical environment changes, computer system 600 transmits one or more instructions to the second window that changes a first property of the second window (e.g., a tint level of the second window) and not a second property of the second window (e.g., the positioning of the second window). In some embodiments, based on a determination being made that one or more characteristics of the physical environment change, computer system 600 transmits one or more instructions to the second window that modify a property (e.g., tint level) of the second window based on the positioning and/or orientation of the second window. In some embodiments, computer system 600 transmits one or more instructions to the second window that adjust the position of the second window in response to detecting an input that corresponds to selection of window control user interface object 632. In some embodiments, based on a determination being made that one or more characteristics of the physical environment change, computer system 600 transmits one or more instructions to a first set of devices located in a first area of the external structure that adjust the operation/positioning of the first set of devices and computer system 600 does not transmit one or more instructions to a second set of devices in a second area of the external structure. In some embodiments, based on a determination being made that one or more sensory characteristics (e.g., visual, auditory, and/or thermal characteristics) of the physical environment change, computer system 600 transmits one or more instructions to one or more devices (e.g., fan, air conditioning device, monitor, playback device, and/or windows) within the external structure that modify the operation and or position of the one or more devices. In some embodiments, computer system 600 is in communication with an actuator that actuates a door. In embodiments where computer system 600 is in communication with an actuator, based on a determination being made that one or more characteristics of the physical environment change, computer system 600 does not transmit one or more instructions to the actuator that cause the actuator to actuate the door. In some embodiments, based on a determination being made that the brightness level of the environment changes, computer system 600 transmits one or more instructions to both the second light device and the and the second window that change the operation and/or positioning of the second light device and the second window.

FIG. 3 is a flow diagram illustrating a method (e.g., process 700) for controlling the operation of one or more electronic devices based on the value of a setting of the electronic device in accordance with some examples. Some operations in process 700 are, optionally, combined, the orders of some operations are, optionally, changed, and some operations are, optionally, omitted.

As described below, process 700 provides an intuitive way for controlling the operation of one or more electronic devices based on the value of a setting of the electronic device. Process 700 reduces the cognitive burden on a user for controlling the operation of one or more electronic devices based on the value of a setting of the electronic device, thereby creating a more efficient human-machine interface. For battery-operated computing devices, enabling a user to control the operation of one or more electronic devices based on the value of a setting of the electronic device faster and more efficiently conserves power and increases the time between battery charges.

In some embodiments, process 700 is performed at a computer system (e.g., 600) that is in communication with a first device (e.g., a device that corresponds to 612, 614, 616, and/or 618) (e.g., an external device, an internal device, a fan, a thermostat, a window, a set of blinds, a speaker, a microphone, and/or a door). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with a display component, such as a display screen and/or a touch-sensitive display. In some embodiments, the computer system is in communication with one or more cameras (e.g., one or more telephoto, wide angle, and/or ultra-wide angle cameras).

At 702, while a first setting corresponding to the first device (e.g., a device that corresponds to 612, 614, 616, and/or 618) is set to a first value (e.g., value of the setting of the device that corresponds to 612, 614, 616, and/or 618) (e.g., a minimum value (e.g., low, 0-10, 0-10%, and/or very low), a non-zero value, a maximum value (e.g., high, very high, 100, and/or 100%), and/or a value that is between a minimum and maximum value for a setting), the computer system causes the first device to provide first output corresponding to (e.g., based on and/or computed using) the first value (and, In some embodiments, that is based on an offset) (e.g., as discussed above at FIG. 2A).

At 704, while causing the first device (e.g., device that corresponds to 612, 614, 616, and/or 618) to provide first output corresponding to the first value (e.g., value of the setting of the device that corresponds to 612, 614, 616, and/or 618), the computer system detects a change in the physical environment (e.g., as discussed above at FIGS. 2B and 2C). In some embodiments, detecting a change in the physical environment includes detecting a change to a characteristic (e.g., amount of light, temperature, amount of air flow, amount of sound). In some embodiments, the change is detected via a sensor of the computer system (e.g., a sensor physically attached to and/or within an enclosure of the computer system).

At 706, in response to detecting the change in the physical environment and in accordance with (708) a determination that the first value (e.g., value of the setting of the device that corresponds to 612, 614, 616, and/or 618) is within a first range of values for the first setting, the computer system causes the first device (e.g., device that corresponds to 612, 614, 616, and/or 618) to provide second output corresponding to (e.g., within, based on, and/or calculated and/or computed using) a first offset (e.g., 0-100% and/or plus or minus 0-100) of the first value, wherein the first offset is computed based on the first value being within the first range of values (e.g., low to medium, medium to high, 10-30, 20-60, 80-100, and/or 20-70) for the first setting (e.g., as described in FIGS. 2C and 2E). In some embodiments, in accordance with a determination that a second value is within the first range of values for the first setting, the computer system causes the first device to provide output corresponding to the first offset of the second value, wherein the first offset is computed based on the second value being within the first range of values for the first setting. In some embodiments, the second value is different from the first value. In some embodiments, the first offset is a maximum and/or minimum amount of change (e.g., caused by changes to the physical environment) to the first setting while within the first range of values. In some embodiments, the first offset is computed based on a current value of environmental data detected via a sensor.

At 706, in response to detecting the change in the physical environment and in accordance with (710) a determination that the first value (e.g., value of the setting of the device that corresponds to 612, 614, 616, and/or 618) is within a second range of values for the first setting that is different from (e.g., not overlapping with) the first range of values for the first setting, the computer system causes the first device (e.g., device that corresponds to 612, 614, 616, and/or 618) to provide a third output corresponding to a second offset of the first value, wherein the second offset (e.g., 0-100% and/or plus or minus 0-100) is computed based on the first value being within the second range of values (e.g., low to medium, medium to high, 10-30, 20-60, 80-100, and/or 20-70) for the first setting, wherein the second output is different from the third output, and wherein the second output and the third output are not one or more of a non-zero minimum output (e.g., for a particular and/or respective setting) and a maximum output (e.g., as described in FIGS. 2C and 2E) (e.g., for a particular and/or respective setting). In some embodiments, the first output is the same as the second output or the third output but not both. In some embodiments, in accordance with a determination that a third value is within the second range of values for the first setting, the computer system causes the first device to provide fourth output corresponding to the first offset of the third value, where the first offset is computed based on the third value being within the second range of values for the first setting. In some embodiments, the third value is different from the second value. In some embodiments, in accordance with a determination that the first value is within a first range of values for the first setting, the computer system forgoes causing the first device to provide third output corresponding to a second offset of the first value. In some embodiments, in accordance with a determination that the first value is within a second range of values for the first setting that is different from the first range of values for the first setting, the computer system forgoes causing the first device to provide second output corresponding to a first offset of the first value. In some embodiments, when the setting is a maximum or minimum value and the change in the environment is a first change, the computer system does not adjust the output of the computer system. In some embodiments, the second offset is a maximum and/or minimum amount of change (e.g., caused by changes to the physical environment) to the first setting while within the second range of values. In some embodiments, the second offset is computed based on a current value of environmental data detected via a sensor. Computing offsets based on the first value being within different ranges of output allows the computer system to react differently depending on what range of values that a current value is in, thereby reducing the number of inputs needed to perform an operation, providing additional control options without cluttering the user interface with additional displayed controls, and/or performing an operation when a set of conditions has been met without requiring further user input.

In some embodiments, the second output corresponds to a value that is within the first offset of the first value (e.g., value of the setting of the device that corresponds to 612, 614, 616, and/or 618) from the first value (e.g., a value between the first value and the first value plus or minus the first offset of the first value). In some embodiments, the third output corresponds to a value that is within the second offset of the first value from the first value (e.g., as described in FIGS. 2C and 2E) (e.g., a value between the first value and the first value plus or minus the first offset of the first value). In some embodiments, the output of the device is adjusted by a value that corresponds to a value that is no more than the first offset from the first value. In some embodiments, the value that is within the first offset is not the first offset. In some embodiments, the value that is within the second offset is not the second offset. In some embodiments, the first output is adjusted by the value that is within the first offset of the first value from the first value to provide, produce, and/or generate the second output. In some embodiments, the first output is adjusted by the value that is within the second offset of the first value from the first value to provide, produce, and/or generate the third output.

In some embodiments, in accordance with a determination that a first difference between the first value (e.g., value of the setting of the device that corresponds to 612, 614, 616, and/or 618) and a terminal value (e.g., a minimum value, a maximum value, and/or a value that is preselected and/or determined by a user) is a first amount, the first offset is a first offset value (e.g., as described in FIG. 2C). In some embodiments, in accordance with a determination that the first difference between the first value and the terminal value is a second amount that is greater than the first amount, the first offset is a second offset value that is greater than the first offset value (e.g., as described in FIG. 2C). In some embodiments, the first offset decreases as the first value approaches a value that is closer to a minimum and/or maximum value. In some embodiments, the first offset increases as the first value approaches a value that is further away from a minimum and/or maximum value. Increasing the offset in accordance with a determination that the first difference between the first value and the terminal value is the second amount that is greater than the first amount allows for the computer system to provide greater changes when further from a terminal value and/or align better with user expectations when setting a value, thereby providing additional control options without cluttering the user interface with additional displayed controls and/or performing an operation when a set of conditions has been met without requiring further user input.

In some embodiments, in accordance with a determination that a second difference between the first value (e.g., value of the setting of the device that corresponds to 612, 614, 616, and/or 618) and a non-terminal value (e.g., a mean value, average value, a middle value, and/or a median value (e.g., for a particular setting and/or out of a particular set of values)) is a third amount, the first offset is a third offset value (e.g., as described above at FIG. 2E). In some embodiments, in accordance with a determination that the second difference between the first value and the non-terminal value is a fourth amount that is greater than the third amount, the first offset is a fourth offset value that is less than the third offset value (e.g., as described above at FIG. 2E). In some embodiments, the first offset decreases as the first value is a value that is further way from to a median value. In some embodiments, the first offset increases as the first value approaches a value that is closer to a median value. Increasing the offset in accordance with a determination that the second difference between the first value and the non-terminal value is a fourth amount that is greater than the third amount allows for the computer system to provide greater changes when closer to the non-terminal value and/or align better with user expectations when setting a value, thereby providing additional control options without cluttering the user interface with additional displayed controls and/or performing an operation when a set of conditions has been met without requiring further user input.

In some embodiments, in accordance with a determination that the first setting is a first type of setting (e.g., a temperature, fan, thermostat, window and/or door (e.g., window and/or door position and/or window and/or door tint), sound, light, and/or seat position setting), the first offset is a fifth offset value and the second offset is a sixth offset value, wherein the fifth offset value is different from (e.g., when subtracting the fifth offset value from the sixth offset value and/or vice versa) the sixth offset value by a fifth amount (e.g., an absolute value of difference) (e.g., as described above at FIGS. 2C, 2E, and 2F). In some embodiments, the first offset is a first percentage. In some embodiments, the second offset is a second percentage that is different from the first percentage. In some embodiments, in accordance with a determination that the first setting is a second type of setting (e.g., a temperature, fan, thermostat, window and/or door (e.g., window and/or door position and/or window and/or door tint), sound, light, and/or seat position setting) that is different from the first type of setting, the first offset is a seventh offset value and the second offset is an eighth offset value, wherein the seventh offset value is different from (e.g., when subtracting the seventh offset value from the eighth offset value and/or vice versa) the eighth offset value by a sixth amount (e.g., an absolute value of difference) that is different from the fifth amount (e.g., as described above at FIGS. 2C, 2E, and 2F). In some embodiments, offsets increase or decrease differently for different types of settings. A respective offset being different depending on a type of setting allows the computer system to cater to the type of setting when changing output in response to changes in the physical environment and/or align better with user expectations when setting a value, thereby providing additional control options without cluttering the user interface with additional displayed controls and/or performing an operation when a set of conditions has been met without requiring further user input.

In some embodiments, before detecting the change in the physical environment, the computer system causes a second device (e.g., device that corresponds to 612, 614, 616, and/or 618) to provide fourth output corresponding to a third value (e.g., value of the setting of the device that corresponds to 612, 614, 616, and/or 618). In some embodiments, in response to detecting the change in the physical environment and in accordance with a determination that the second device is associated with a first area and a second area (and, In some embodiments, in accordance with a determination that the second device is global device and/or associated with the computer system as a whole), the computer system causes the second device to provide fifth output corresponding to an offset of the third value while causing the first device (e.g., device that corresponds to 612, 614, 616, and/or 618) to provide the second output or the third output (e.g., as described above at FIG. 2C). In some embodiments, in response to detecting the change in the physical environment and in accordance with a determination that the second device is associated with the first area but not the second area (and, In some embodiments, in accordance with a determination that the second device is local device and/or associated with only a portion of the computer system), the computer system forgoes causing the second device to provide the fifth output corresponding to the offset of the third value while causing the first device to provide the second output or the third output (e.g., as described above at FIG. 2C). In some embodiments, in accordance with a determination that the second device is associated with the first area but not the second area, the computer system continues causing the second device to provide the fourth output corresponding to the third value. Selectively causing the second device to provide fifth output in accordance with a determination that the second device is associated with the first area or the second area allows the computer system to determine whether to change outputs based on a location of a device that is being changed, thereby providing additional control options without cluttering the user interface with additional displayed controls and/or performing an operation when a set of conditions has been met without requiring further user input.

In some embodiments, before detecting the change in the physical environment, the computer system causes a third device (e.g., device that corresponds to 612, 614, 616, and/or 618) to provide sixth output corresponding to a fourth value (e.g., value of the setting of the device that corresponds to 612, 614, 616, and/or 618). In some embodiments, in response to detecting the change in the physical environment (and, In some embodiments, irrespective of whether the third device is a global device and/or a local device and/or irrespective of whether the third device is associated with only a portion of the computer system and/or associated with the computer system as a whole), the computer system causes the third device to provide seventh output corresponding to an offset of the fourth value while causing the first device (e.g., device that corresponds to 612, 614, 616, and/or 618) to provide the second output or the third output (e.g., irrespective of an area with which the third device is associated) (e.g., as described above at FIG. 2C). In some embodiments, the sixth output is different from the seventh output. Causing the third device to change output in response to detecting the change in the physical environment while also causing the first device to change output allows for the computer system to change multiple outputs optionally in different areas of a physical environment to, for example, provide more global changes to changes in the environment, thereby providing additional control options without cluttering the user interface with additional displayed controls and/or performing an operation when a set of conditions has been met without requiring further user input.

In some embodiments, while causing the first device (e.g., device that corresponds to 612, 614, 616, and/or 618) to provide second output corresponding to the first offset of the first value (e.g., value of the setting of the device that corresponds to 612, 614, 616, and/or 618), the computer system detects a request to change a value of the first setting from the first value to a fifth value (e.g., value of the setting of the device that corresponds to 612, 614, 616, and/or 618) that is different from the first value. In some embodiments, the computer system detects the request to change the value of the first setting from the first value to the fifth value by detecting an input, such as a dragging input (e.g., on a scale for the setting and/or that moves an indication between one or more values that corresponding to the setting) and/or a non-dragging input (e.g., a tap input, a voice input and/or command, an air gesture (e.g., a pinch and twist gesture, a pointing gesture, and/or a pinch and move gesture), a mouse click, and/or a gaze input). In some embodiments, in response to detecting the request to change the value of the first setting from the first value to the fifth value that is different from the first value, the computer system changes the value of the first setting from the first value to the fifth value (e.g., setting and/or configuring the first setting to be the fifth value). In some embodiments, in response to detecting the request to change the value of the first setting from the first value to the fifth value that is different from the first value, the computer system causes the first device to provide eighth output corresponding to an offset of the fifth value, wherein the offset of the fifth value is different from the first offset of the first value. Changing an offset in response to detecting the request to change the value of the first setting from the first value to the fifth value used allows for the computer system to adapt to manual changes by a user and/or align better with user expectations when setting a value, thereby providing additional control options without cluttering the user interface with additional displayed controls and/or performing an operation when a set of conditions has been met without requiring further user input.

In some embodiments, the first device (e.g., device that corresponds to 612, 614, 616, and/or 618) includes a fan, window, temperature control, light, heating element, or any combination thereof.

In some embodiments, detecting the change in the physical environment includes detecting a change in an amount (e.g., 0-200 lux) of light (e.g., ambient light) in the physical environment (e.g., as discussed above at FIGS. 2C and 2F).

In some embodiments, detecting the change in the physical environment includes detecting a change in temperature (e.g., a change in degrees of temperature) of the physical environment (e.g., as discussed above at FIG. 2C).

In some embodiments, detecting the change in the physical environment includes detecting a change in sound (e.g., amount (e.g., intensity, pitch, level, volume, and/or numbers of sound waves) of sound) (e.g., a change in sound that is determined to be a particular type of sound, such as ambient sound, background sound, and/or noise) in the physical environment (e.g., as discussed above at FIG. 2C).

In some embodiments, before detecting the change in the physical environment, the computer system causes a fourth device (e.g., device that corresponds to 612, 614, 616, and/or 618) to provide ninth output and causing a fifth device (e.g., device that corresponds to 612, 614, 616, and/or 618) to provide tenth output, wherein the fifth device is different from the fourth device. In some embodiments, in response to detecting the change in the physical environment and in accordance with a determination that the change to the physical environment is detected to be a change to the physical environment that is internal (e.g., internal to a housing of the computer system, to a space that computer system occupies, and/or to the computer system) (e.g., and not external (e.g., external to the housing of the computer system, to the space that computer system occupies, and/or to the computer system)), the computer system causes the fourth device to provide eleventh output while continuing to cause the fifth device to provide tenth output (and, In some embodiments, while ceasing to cause the fourth device to provide the eighth output), wherein the eleventh output is different from the ninth output (e.g., as described above at FIG. 2C). In some embodiments, in response to detecting the change in the physical environment and in accordance with a determination that the change to the physical environment is detected to be a change to the physical environment that is external (e.g., external to the housing of the computer system, to the space that computer system occupies, and/or to the computer system) (e.g., to the computer system and not internal to the computer system), the computer system causes the fifth device to provide twelfth output while continuing to cause the fourth device to provide ninth output, wherein the twelfth output is different from the tenth output (and, In some embodiments, while ceasing to cause the fifth device to provide the nineth output) (e.g., as described above at FIG. 2C). In some embodiments, in accordance with a determination that the change to the physical environment is detected to be a change to the physical environment that is external and internal, the computer system causes the fourth device to provide eleventh output and the fifth device to provide twelfth output. Causing different devices to change output in accordance with a determination that the change to the physical environment is detected to be a change to the physical environment that is internal or external allows for the computer system to change outputs of devices that are more likely and/or better situated to affect the change to the physical environment, thereby performing an operation when a set of conditions has been met without requiring further user input.

Note that details of the processes described above with respect to process 700 (e.g., FIG. 3) are also applicable in an analogous manner to other methods described herein. For example, process 1000 optionally includes one or more of the characteristics of the various methods described above with reference to process 700. For example, a device can be adjusted based on the orientation of a light source using one or more techniques described below in relation to 1000, where the amount that the device is adjusted is based on an offset using one or more techniques described above in relation to 700. For brevity, these details are not repeated below.

FIG. 4 is a flow diagram illustrating a method (e.g., process 800) for adjusting the state of certain types of electronic devices in accordance with some examples. Some operations in process 800 are, optionally, combined, the orders of some operations are, optionally, changed, and some operations are, optionally, omitted.

As described below, process 800 provides an intuitive way for adjusting the state of certain types of electronic devices. Process 800 reduces the cognitive burden on a user for adjusting the state of certain types of electronic devices, thereby creating a more efficient human-machine interface. For battery-operated computing devices, enabling a user to adjust the state of certain types of electronic devices faster and more efficiently conserves power and increases the time between battery charges.

In some embodiments, process 800 is performed at a computer system (e.g., 600) that is in communication with a first device (e.g., device that corresponds to 612, 614, 616, and/or 618) (e.g., a fan, a thermostat, a window, a set of blinds, a speaker, a microphone, and/or a door). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with a display component, such as a display screen and/or a touch-sensitive display. In some embodiments, the computer system is in communication with one or more cameras (e.g., one or more telephoto, wide angle, and/or ultra-wide angle cameras).

At 802, while a first setting corresponding to the first device (e.g., device that corresponds to 612, 614, 616, and/or 618) is set to a first value (e.g., value of the setting of the device that corresponds to 612, 614, 616, and/or 618) (e.g., a minimum value (e.g., low, 0-10, 0-10%, and/or very low), a non-zero value, a maximum value (e.g., high, very high, 100, and/or 100%), and/or a value that is between a minimum and maximum value for a setting), the computer system (e.g., 600) causes the first device (e.g., device that corresponds to 612, 614, 616, and/or 618) to provide first output corresponding to (e.g., based on and/or computed using) an offset (e.g., 0-100% and/or plus or minus 0-100) of (e.g., based on and/or computed using) the first value (and, In some embodiments, that is based on an offset).

At 804, while causing the first device (e.g., device that corresponds to 612, 614, 616, and/or 618) to provide first output corresponding to the first value (e.g., value of the setting of the device that corresponds to 612, 614, 616, and/or 618), the computer system (e.g., 600) detects a change to a first characteristic in the physical environment (e.g., as described above at FIGS. 2C and 2F). In some embodiments, detecting a change in the physical environment includes detecting a change to a characteristic (e.g., amount of light, temperature, amount of air flow, amount of sound).

At 806, in response to detecting the change to the first characteristic (e.g., temperature, amount of light, amount of air flow, and/or amount of sound) of the physical environment and in accordance with (808) a determination that output of the first device (e.g., device that corresponds to 612, 614, 616, and/or 618) impacts the first characteristic of the physical environment (e.g., output from the device causes or can cause the first characteristic to change and/or impacts a value (e.g., temperature value, noise level, air flow speed, and/or brightness value, such as lux) associated with the characteristic) and the first device is a first type of device, the computer system causes (810) the offset of the first value (e.g., value of the setting of the device that corresponds to 612, 614, 616, and/or 618) to be adjusted (e.g., by the computer system and/or by the first device).

At 806, in response to detecting the change to the first characteristic of the physical environment, in accordance with (808) the determination that output of the first device impacts the first characteristic of the physical environment and the first device is the first type of device, the computer system causes (812) the first device (e.g., device that corresponds to 612, 614, 616, and/or 618) to provide output corresponding to the adjusted offset of the first value (e.g., as described above at FIGS. 2C and 2E).

At 806, in response to detecting the change to the first characteristic (e.g., temperature, amount of light, amount of air flow, and/or amount of sound) of the physical environment and in accordance with (814) a determination that output of the first device (e.g., device that corresponds to 612, 614, 616, and/or 618) impacts the first characteristic of the physical environment and the first device is a second type of device that is different from the first type of device, the computer system forgoes (816) causing the offset of the first value (e.g., value of the setting of the device that corresponds to 612, 614, 616, and/or 618) to be adjusted.

At 806, in response to detecting the change to the first characteristic (e.g., temperature, amount of light, amount of air flow, and/or amount of sound) of the physical environment and in accordance with (814) the determination that output of the first device impacts the first characteristic of the physical environment and the first device is the second type of device that is different from the first type of device, the computer system continues to cause (818) the first device (e.g., device that corresponds to 612, 614, 616, and/or 618) to provide first output corresponding to the offset of the first value (e.g., as described above at FIG. 2F). Causing the offset of the first value to be adjusted and causing the first device to provide output corresponding to the adjusted offset of the first value or continuing to cause the first device to provide first output corresponding to the offset of the first value without causing the offset of the first value to be adjusted when prescribed conditions are met allows the computer system to automatically cause the offset to be adjusted or not cause the offset to be adjusted to impact the output of the device based on the type of device that impacts the physical environment, thereby performing an operation when a set of conditions has been met without requiring further user input.

In some embodiments, the first characteristic is a sensory characteristic (e.g., as described above at FIGS. 2C and 2F) (e.g., a visual, auditory, and/or thermal characteristics). In some embodiments, a non-sensory characteristic is a characteristic of a physical environment that cannot be readably determined by the user (e.g., amount of gas and/or molecules in an environment). Causing the offset of the first value to be adjusted and causing the first device to provide output corresponding to the adjusted offset of the first value or continuing to cause the first device to provide first output corresponding to the offset of the first value without causing the offset of the first value to be adjusted when prescribed conditions are met allows the computer system to automatically cause the offset to be adjusted or not cause the offset to be adjusted to impact the output of the device based on the type of device that impacts a sensory characteristic of the physical environment, thereby performing an operation when a set of conditions has been met without requiring further user input.

In some embodiments, in accordance with a determination that the first device (e.g., device that corresponds to 612, 614, 616, and/or 618) is the first type of device, the first output corresponding to the offset of the first value (e.g., value of the setting of the device that corresponds to 612, 614, 616, and/or 618) is a first type of output (e.g., heating, cooling, sound, tint/opacity, light, and/or positioning (e.g., seat positioning and/or window positioning) output). In some embodiments, in accordance with a determination that the first device is the second type of device, the first output corresponding to the offset of the first value is a second type of output (e.g., heating, cooling, sound, tint/opacity, light, and/or positioning (e.g., seat positioning and/or window positioning) output) that is different from the first type of output (e.g., as described above at FIG. 2F). Causing the offset of the first value to be adjusted and causing the first device to provide output corresponding to the adjusted offset of the first value or continuing to cause the first device to provide first output corresponding to the offset of the first value without causing the offset of the first value to be adjusted when prescribed conditions are met allows the computer system to automatically cause the offset to be adjusted or not cause the offset to be adjusted to impact the output of the device based on the type of device that impacts the physical environment, where the type of device can be dependent on the output that the device provides, thereby performing an operation when a set of conditions has been met without requiring further user input.

In some embodiments, the first device (e.g., device that corresponds to 612, 614, 616, and/or 618) is caused to provide a first type of output (e.g., cold air, hot air, light, and/or sound) that has a first type of impact (e.g., increase temperature, decrease temperature, increase amount of light in physical environment, decrease amount of light in physical environment, decrease amount of sound in physical environment, and/or increase amount of sound in physical environment) on the first characteristic of the physical environment. In some embodiments, in response to detecting the change to the first characteristic of the physical environment and in accordance with a determination that output of a second device (e.g., device that corresponds to 612, 614, 616, and/or 618) impacts the first characteristic of the physical environment, wherein the second device is a different type of device than the first device, the computer system causes an offset of a second value (e.g., value of the setting of the device that corresponds to 612, 614, 616, and/or 618) to be adjusted. In some embodiments, in response to detecting the change to the first characteristic of the physical environment and in accordance with the determination that output of the second device impacts the first characteristic of the physical environment, wherein the second device is the different type of device than the first device, the computer system causes the second device to provide output corresponding to the adjusted offset of the second value (while, In some embodiments, causing the first device to provide output corresponding to the adjusted offset of the first value and/or causing the offset of the first value to be adjusted), wherein the second device is caused to provide a second type of output that has a second type of impact on the first characteristic of the physical environment, and wherein the second type of impact is different from (e.g., opposite of) the first type of impact (e.g., as described above at FIG. 2F). Causing an offset of a second value to be adjusted and causing the second device to provide output corresponding to the adjusted offset of the second value that has different impact when prescribed conditions are met allows the computer system to automatically cause the offset of the second value to be adjusted and cause the second device to provide a different type of output (e.g., in view of the output of the first device) corresponding to the second value (while, In some embodiments, causing the first device to provide output based on an offset), thereby performing an operation when a set of conditions has been met without requiring further user input.

In some embodiments, the first device (e.g., device that corresponds to 612, 614, 616, and/or 618) is caused to provide a third type of output that has a third type of impact on the first characteristic of the physical environment. In some embodiments, in response to detecting the change to the first characteristic of the physical environment and in accordance with a determination that output of a third device (e.g., device that corresponds to 612, 614, 616, and/or 618) impacts the first characteristic of the physical environment, wherein the third device is a different type of device than the first device, the computer system causes an offset of a third value (e.g., value of the setting of the device that corresponds to 612, 614, 616, and/or 618) to be adjusted. In some embodiments, in response to detecting the change to the first characteristic of the physical environment and in accordance with the determination that output of the third device impacts the first characteristic of the physical environment, wherein the third device is the different type of device than the first device, the computer system causes the third device to provide output corresponding to the adjusted offset of the third value (while, In some embodiments, causing the first device to provide output corresponding to the adjusted offset of the first value and/or causing the offset of the first value to be adjusted), wherein the third device is caused to provide the third type of output that has the third type of impact on the first characteristic of the physical environment (e.g., as described above at FIG. 2F). Causing an offset of a third value to be adjusted and causing the third device to provide output corresponding to the adjusted offset of the third value that has different impact when prescribed conditions are met allows the computer system to automatically cause the offset of the third value to be adjusted and cause the third device to provide a same type of output (e.g., in view of the output of the first device) corresponding to the third value (while, In some embodiments, causing the first device to provide output based on an offset), thereby performing an operation when a set of conditions has been met without requiring further user input.

In some embodiments, the first device (e.g., device that corresponds to 612, 614, 616, and/or 618) provides a fourth type of output and a fifth type of output that is different from the fourth type of output. In some embodiments, causing the first device to provide output corresponding to the adjusted offset of the first value (e.g., value of the setting of the device that corresponds to 612, 614, 616, and/or 618) includes causing the first device to adjust the fourth type of output (e.g., causing tint and/or the opacity of a window and/or door to be adjusted) without causing the first device to adjust the fifth type of output (e.g., as described above at FIG. 2F) (e.g., without causing the position of at least a portion of the first device to change (e.g., a window and/or door being opened and/or closed)). Causing the first device the first device to adjust the fourth type of output without causing the first device to adjust the fifth type of output when prescribed conditions are met allows the computer system to adjust a certain type of output provided by the first device, thereby performing an operation when a set of conditions has been met without requiring further user input.

In some embodiments, while causing the first device (e.g., device that corresponds to 612, 614, 616, and/or 618) to provide first output corresponding to the first value (e.g., value of the setting of the device that corresponds to 612, 614, 616, and/or 618), the computer system detects a request to change the first value to a fourth value (e.g., value of the setting of the device that corresponds to 612, 614, 616, and/or 618) that is different from the first value. In some embodiments, the computer system detects a request to change the first value to a fourth value that is different from the first value by detecting an input, such as a dragging input (e.g., on a scale for the setting and/or that moves an indication between one or more values that corresponding to the setting) and/or a non-dragging input (e.g., a tap input, a voice input and/or command, an air gesture (e.g., a pinch and twist gesture, a pointing gesture, and/or a pinch and move gesture), a mouse click, and/or a gaze input). In some embodiments, in response to detecting the request to change the first value to a fourth value that is different from the first value and in accordance with a determination that the fourth value is a fifth value (e.g., value of the setting of the device that corresponds to 612, 614, 616, and/or 618), the computer system causes the first device to provide output corresponding to an offset of the fifth value. In some embodiments, in response to detecting the request to change the first value to the fourth value that is different from the first value and in accordance with a determination that the fourth value is a sixth value (e.g., value of the setting of the device that corresponds to 612, 614, 616, and/or 618) that is different from the fifth value, the computer system causes the first device to provide output corresponding to an offset of the sixth value, wherein the offset of the fifth value is different from the offset of the sixth value (e.g., the value of the offset of the fifth value is different from the value of the offset of the sixth value). Causing the first device to provide output corresponding to an offset of a particular value when prescribed conditions are met in response to detecting the request to change the first value to a fourth value that is different from the first value provides the user with control over the computer system to change the offset of a particular value, thereby providing additional control options without cluttering the user interface with additional displayed controls.

In some embodiments, the computer system (e.g., 600) is in communication with a display component. In some embodiments, before detecting the change to the first characteristic of the physical environment, the computer system displays, via the display component, an indicator (e.g., a graphical representation (e.g., a fan, light, thermostat, window, and/or sound indicator), a textual representation, and/or a symbolic representation) that corresponds to the first device (e.g., device that corresponds to 612, 614, 616, and/or 618), wherein the indicator is displayed with a first visual appearance (e.g., a first set of one or more colors, graphical representations and/or icons, and/or text). In some embodiments, in response to detecting the change to the first characteristic of the physical environment and in accordance with a determination that output of the first device impacts the first characteristic of the physical environment and in accordance with a determination that the first device is the first type of device, the computer system ceases to display the indicator with the first visual appearance and displays the indicator with a second visual appearance (e.g., a first set of one or more colors, graphical representations and/or icons, and/or text) that is different from the first visual appearance. In some embodiments, in response to detecting the change to the first characteristic of the physical environment and in accordance with a determination that output of the first device impacts the first characteristic of the physical environment and in accordance with a determination that the first device is the second type of device, the computer system continues to display the indicator with the first visual appearance (and, In some embodiments, without displaying the indicator with the second visual appearance). In some embodiments, some types of indicators (e.g., indicators corresponding to different settings) change but others do not when one or more characteristics of the physical environment changes. Choosing to display the indicator with the first visual appearance or the second visual appearance when prescribe conditions are met allows the computer system to automatically provide visual feedback to the user based on the type of device that is impacting the physical environment, thereby performing an operation when a set of conditions has been met without requiring further user input and providing improved feedback.

In some embodiments, before detecting the change to the first characteristic of the physical environment, the computer system displays, via the display component (e.g., 608), a scale (e.g., 624 and/or 632) indicating a plurality of values for setting output of the first device (e.g., device that corresponds to 612, 614, 616, and/or 618), wherein the plurality of values includes the first value (e.g., value of the setting of the device that corresponds to 612, 614, 616, and/or 618). In some embodiments, in response to detecting the change to the first characteristic of the physical environment and in accordance with a determination that output of the first device impacts the first characteristic of the physical environment and in accordance with a determination that the first device is the first type of device (e.g., and/or in accordance with causing the first device to provide output corresponding to the adjusted offset of the first value), the computer system changes an appearance of the scale (e.g., as discussed above at FIGS. 2C, 2D, and 2E) (e.g., changing and/or moving an indicator from a first position to a second position on the scale). In some embodiments, in response to detecting the change to the first characteristic of the physical environment and in accordance with a determination that output of the first device impacts the first characteristic of the physical environment and in accordance with a determination that the first device is the second type of device (e.g., and/or in accordance with continuing to cause the first device to provide first output corresponding to the offset of the first value), the computer system forgoes changing the appearance of the scale (e.g. as discussed above at FIG. 2F) (e.g., forgoing changing and/or moving an indicator from a first position to a second position on the scale). In some embodiments, some types of scales (e.g., scales corresponding to different settings) change but others do not when one or more characteristics of the physical environment changes. Choosing to display the appearance of the scale when prescribe conditions are met allows the computer system to automatically provide visual feedback to the user based on the type of device that is impacting the physical environment, thereby performing an operation when a set of conditions has been met without requiring further user input and providing improved feedback.

In some embodiments, detecting the change to the first characteristic of the physical environment includes detecting a change in orientation of the computer system (e.g., 600) and detecting that the first characteristic in the physical environment has changed by an amount. In some embodiments, the output that changes is the opacity of a window and/or door. In some embodiments, detecting the change to the first characteristic of the physical environment includes detecting a change in orientation of the computer system and does not include detecting that the first characteristic in the physical environment has changed by an amount. In some embodiments, detecting the change to the first characteristic of the physical environment includes detecting that the first characteristic in the physical environment has changed by an amount and does not include detecting a change in orientation of the computer system. Causing the offset of the first value to be adjusted and causing the first device to provide output corresponding to the adjusted offset of the first value or continuing to cause the first device to provide first output corresponding to the offset of the first value without causing the offset of the first value to be adjusted in response to detecting a change in orientation of the computer system and detecting that the first characteristic in the physical environment has changed by an amount when prescribed conditions are met allows the computer system to automatically cause the offset to be adjusted or not cause the offset to be adjusted to impact the output of the device based on the type of device that impacts the physical environment in response to detecting a change in orientation of the computer system and detecting that the first characteristic in the physical environment has changed by an amount, thereby performing an operation when a set of conditions has been met without requiring further user input.

In some embodiments, the first device (e.g., device that corresponds to 612, 614, 616, and/or 618) is a respective type of device based on a location with which the first device is associated (e.g., location within the computer system, right side, left side, bottom, top, and/or central location) (e.g., as described above at FIG. 2F). In some embodiments, in accordance with the first device being in (e.g., a determination that the first device is in) a first location, the first device is a first respective type of device, and, in accordance with the first device being in a second location different from the first location, the first device is a second respective type of device different from the first type of device.

In some embodiments, the second type of device (e.g., device that corresponds to 612, 614, 616, and/or 618) includes an actuator (e.g., a window actuator and/or door actuator) that controls (e.g., moves, adjusts, pulls, and/or pushes) a surface that covers (and/or with respect to and/or in relation to) an opening (e.g., a space and/or a void within the device). In some embodiments, the second type of device includes a window and/or door. In some embodiments, the second type of device include an actuator that adjusts an amount of space (e.g., amount of openness of a space) between a second portion of a device and a reference surface (e.g., a second surface of the first device and/or a surface of another material, device, component, and/or physical entity in a physical environment).

In some embodiments, the first type of device (e.g., device that corresponds to 612, 614, 616, and/or 618) includes a fan, a light, or any combination thereof (e.g., as discussed above at FIG. 2C). In some embodiments, the second type of device does not include the fan, the light, or any combination thereof.

Note that details of the processes described above with respect to process 800 (e.g., FIG. 4) are also applicable in an analogous manner to other methods described herein. For example, process 1000 optionally includes one or more of the characteristics of the various methods described above with reference to process 800. For example, a device can be adjusted based on the orientation of a light source using one or more techniques described below in relation to 1000, where the amount that the device is adjusted is based on an offset using one or more techniques described above in relation to 800. For brevity, these details are not repeated below.

FIGS. 5A-5B illustrate exemplary user interfaces for adjusting the state of one or more electronic devices based on environmental conditions in accordance with some examples. The user interfaces in these figures are used to illustrate the processes described below, including the processes in FIG. 6.

As illustrated in FIG. 5A, computer system 600 displays controls user interface 608. At FIG. 5A, first window control user interface object 616 indicates that the first window of the external structure (e.g., boat, airplane, house, car, a smart house, a smart car, and/or smart boat) is in a closed position, and second window control user interface object 618 indicates that the second window of the external structure is halfway opened.

FIG. 5A also includes schematic 904, which includes representation of external structure 906, representation of first window 908, representation of second window 910, and representation of sun 912. The positional relationship of representation of first window 908 and representation of second window 910 within representation of external structure 906 corresponds to the real-world positioning of the first window and the second window within the external structure. Accordingly, the first window is positioned on the left side of the external structure, and the second window is positioned on the right side of the external structure. Further, the positioning of representation of sun 912 within schematic 904 relative to the positioning of representation of external structure 906 represents the real-world position of the sun relative to the external structure. Accordingly, at FIG. 5A, the sun is positioned to the left of the external structure. Because the sun is positioned to the left of the external structure, the left portion of the external structure receives more light (e.g., is brighter) from the sun than the right portion of the external structure.

At FIG. 5A, a determination is made that one or more external light sources (e.g., the sun (e.g., sun 912), the moon, a street lamp, and/or an oncoming light) is positioned to the left of the external structure. Because a determination is made that the one or more external light sources is positioned to the left of the external structure, computer system 600 transmits one or more instructions to the first window of the external structure that cause the position of the first window to be adjusted (e.g., become more opened and/or closed or more tinted and/or less tinted). Further, at FIG. 5A, because a determination is made that the one or more external light sources is positioned to the left of the external structure, computer system 600 transmits one or more instructions to the second window of the external structure that cause the position of the second window to be adjusted. That, is computer system 600 adjusts one or more characteristics (e.g., positioning and/or amount of tint) of the first window and/or the second window based on the detected position of the one or more external light sources relative to the external structure. In some embodiments, computer system 600 adjusts one or more characteristics (e.g., positioning and/or amount of tint) of the first window and/or the second window based on the detected position of the one or more external light sources relative to computer system 600. In some embodiments, computer system 600 adjusts one or more characteristics (e.g., positioning and/or amount of tint) of the first window and/or the second window based on the detected position of the one or more external light sources relative to a user.

At FIG. 5B, the positioning of the external structure relative to the positioning of the one or more external light sources changes (e.g., in comparison to the positioning of the external structure relative to sun 912 at FIG. 5A), such that the one or more external light sources is positioned to the right of the external structure (e.g., as indicated by the positioning of sun 912 relative to external structure 906 in schematic 904). At FIG. 5B, because a determination is made that one or more external light sources is positioned to the right of the external structure, computer system 600 transmits one or more instructions to the second window that cause the second window to transition from being 50% opened to 0% opened (e.g., 100% closed). Further, at FIG. 5B, because a determination is made that the one or more external light sources is positioned to the right of the external structure, computer system 600 transmits one or more instructions to the first window of the external structure that cause the first window to transition from 0% opened to 50% opened. In some embodiments, because a determination is made that the one or more external light sources is positioned to the right of the external structure, computer system 600 transmits one or more instructions to the first window and/or second window that cause the opacity of the first window and/or second window to increase and/or decrease. In some embodiments, because a determination is made that the one or more external light sources is positioned to the right of the external structure, computer system 600 transmits one or more instructions to the second that cause the second window to transition from the closed positioned to the opened position. In some embodiments, one or more of the windows can be adjusted to other positions or amounts (e.g., 0-100%) of openness (or closeness) other than 0%, 50%, and/or 100%. In some embodiments, the amount that a respective window is adjusted is dependent on the intensity of the one or more external light sources while the one or more external light sources is positioned at a particular location in the physical environment.

As explained above, computer system 600 adjusts the positioning of the first window and the second window based on the position of the one or more external light sources relative to the external structure. In some embodiments, computer system 600 transmits one or more to the first window and the second window at the same time. In some embodiments, computer system 600 transmits one or more instructions to the first window prior to transmitting one or more instructions the second window or vice versa. In some embodiments, when a determination is made that the one or more external light sources is positioned to the right of the external structure, computer system 600 transmits one or more instructions to the first window that gradually (e.g., over a period of time (e.g., 5, 7, 10, 15, 25, 30, or 45 seconds)) adjust (e.g., increase) the tint level of the first window to a default value (e.g., a value set by the user or a value set by the manufacturer of the external structure). In some embodiments, when a determination is made that the one or more external light sources is positioned to the right of the external structure, computer system 600 forgoes transmitting one or more instructions to the first window. In some embodiments, when a determination is made that the one or more external light sources is positioned to the right of the external structure, computer system 600 transmits one or more instructions to the second window that decrease the tint level of the second window.

At FIG. 5B, computer system 600 updates the display of first window control user interface object 616 to indicate the new positioning of the first window. Accordingly, as illustrated in FIG. 5B, computer system 600 displays first window control user interface object 616 with an indication that the first window is half opened. Further, at FIG. 5B, computer system 600 updates the display of second window control user interface object 618 to indicate the new positioning of the second window. Accordingly, as illustrated in FIG. 5B, computer system 600 displays second window control user interface object 618 with an indication that the second window is closed. In some embodiments, computer system 600 adjusts a characteristic of the first window and/or second window that is preset by a user based on the detected positioning of the one or more external light sources. In some embodiments, when a determination is made that the one or more external light sources is positioned to the right of the external structure, computer system 600 adjusts a characteristic of the first window based on the value of a setting of the first window that is set by a user. In some embodiments, based on the detected position of the one or more external light sources, computer system 600 transmits one or more instructions to the first window and/or second window that adjust two or more characteristics of the first window and/or the second window (e.g., position, amount of tint, amount of opacity, and/or size). In some embodiments, based on the detected position of the one or more external light sources, computer system 600 transmits one or more instructions to the first window and/or second window that adjust the tint of the first window and/or second window and does not adjust the position of the first window and/or second window or vice versa. In some embodiments, based on the detected position of the one or more external light sources, computer system 600 transmits one or more instructions to the first window, the second window, and a third window of the external structure that concurrently adjust the same characteristic of each respective window. In some embodiments, based on the detected position of the one or more external light sources, computer system 600 transmits one or more instructions to the first window, the second window, and the third window of the external structure that adjust different characteristics of each respective window. In some embodiments, based on the detected position of a source of one or more characteristics of (e.g., noise, brightness, and/or smell) the physical environment, computer system 600 transmits one or more instructions to one or more playback devices of the external structure that adjust the playback status of the one or more playback devices, adjust the operation (e.g., brightness, powers on, powers off) of the one or more light devices, and/or adjust one or more characteristics of a window. In some embodiments, in response to detecting that the intensity of the one or more external light sources and/or of another light source has changed, computer system 600 adjusts one or more characteristics of the window (e.g., irrespective of whether the actual position of the one or more external light sources has changed). In some embodiments, computer system 600 can adjusts a window when a determination is made that brightness of an area impacted by the one or more light sources changes (e.g., due to cloud cover and/or due to one or more objects between the sun and the area) and/or the temperature of an area impacted by the sun changes, even in situations where the sun remains detected on a particular side of the external structure.

FIG. 6 is a flow diagram illustrating a method (e.g., process 1000) for adjusting the state of one or more electronic devices based on environmental conditions in accordance with some examples. Some operations in process 1000 are, optionally, combined, the orders of some operations are, optionally, changed, and some operations are, optionally, omitted.

As described below, process 1000 provides an intuitive way for adjusting the state of one or more electronic devices based on environmental conditions. Process 1000 reduces the cognitive burden on a user for adjusting the state of one or more electronic devices based on environmental conditions, thereby creating a more efficient human-machine interface. For battery-operated computing devices, enabling a user to adjust the state of one or more electronic devices based on environmental conditions faster and more efficiently conserves power and increases the time between battery charges.

In some embodiments, process 1000 is performed at a computer system (e.g., 600) that is in communication with a first device (e.g., 908 and/or 910) (e.g., an external device, an internal device, a fan, a thermostat, a window, a set of blinds, a speaker, a microphone, and/or a door) and a second device (e.g., 908 and/or 910). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with a display component, such as a display screen and/or a touch-sensitive display. In some embodiments, the computer system is in communication with one or more cameras (e.g., one or more telephoto, wide angle, and/or ultra-wide angle cameras).

At 1002, while the first device (e.g., 908 and/or 910) corresponds to a first area (e.g., of the computer system and/or within the interior of an object and/or computer system) and the second device (e.g., 908 and/or 910) corresponds to a second area (e.g., of the computer system and/or within the interior of an object and/or computer system) that is different from the first area, the computer system detects a change in an orientation of a light source (e.g., 912) (e.g., the sun and/or a light bulb) (e.g., a light source in the physical environment and/or in an environment that is external to the computer system and/or a housing of the computer system) relative to a respective object (e.g., the computer system, a housing of the computer system, and/or another computer system).

At 1004, in response to detecting the change in orientation of the light source (e.g., 912) relative to the respective object and in accordance with (e.g., 1006) a determination that the changed orientation of the light source (e.g., 912) relative to the respective object is a first orientation (e.g., and/or that an amount of light from the light source is impacting the first area more than the second area), the computer system causes a characteristic of the first device (e.g., 908 and/or 910) to be adjusted in a first manner (e.g., increased or decreased) without causing the characteristic of the second device (e.g., 908 and/or 910) to be adjusted in the first manner. In some embodiments, accordance with a determination that the position of light source relative to the computer system corresponds to the first area and not the second area, the computer system causes the characteristic of the second device to be adjusted in a second manner that is different from and/or opposite of the first manner, or the computer system does not cause the characteristic of the second device to be adjusted.

At 1004, in response to detecting the change in orientation of the light source relative to the respective object, in accordance with (e.g., 1008) a determination that the changed orientation of the light source (e.g., 912) relative to the respective object is a second orientation (e.g., and/or that an amount of light from the light source is impacting the second area more than the first area) different from the first orientation, the computer system causes the characteristic of the second device (e.g., 908 and/or 910) to be adjusted in the first manner without causing the characteristic of the first device (e.g., 908 and/or 910) to be adjusted in the first manner. In some embodiments, in accordance with a determination that the position of light source relative to the computer system corresponds to the second area and not the first area, the computer system causes the characteristic of the first device to be adjusted in the second manner that is different from and/or opposite of the first manner, or the computer system does not cause the characteristic of the first device to be adjusted. Causing a characteristic of a particular device to be adjusted in a first manner without causing the characteristic of the another particular device to be adjusted in the first manner when prescribed conditions are met allows the computer system to automatically adjusts a characteristic of a particular device based on the orientation to the respective object (e.g., without adjusting the characteristic of another particular device), thereby reducing the number of inputs needed to perform an operation and/or performing an operation when a set of conditions has been met without requiring further user input.

In some embodiments, while in the first orientation, the light source (e.g., 912) impacts (e.g., directly impacts, is directed to, and/or is output in the direction of) the first area more than the second area that is different from the second area (e.g., as described above at FIG. 5A). In some embodiments, while in the second orientation, the light source impacts the second area more than the first area (e.g., as described above at FIG. 5A).

In some embodiments, causing the characteristic of the first device (e.g., 908 and/or 910) (and/or causing the characteristic of the second device) to be adjusted in the first manner includes adjusting (e.g., increasing or decreasing) a first opacity (and/or tint) of a first portion of the first device (and/or second device) (e.g., as described above at FIG. 5A). Adjusting a first opacity of a first portion of the first device when prescribed conditions are met allows the computer system to automatically change the opacity of a particular device, thereby reducing the number of inputs needed to perform an operation and/or performing an operation when a set of conditions has been met without requiring further user input.

In some embodiments, causing the characteristic of the first device (e.g., 908 and/or 910) (and/or second device) to be adjusted in the first manner includes adjusting an amount of space (e.g., amount of openness of a space) between a second portion of the first device and a reference surface (e.g., as described above at FIG. 5B) (e.g., a second surface of the first device and/or a surface of another material, device, component, and/or physical entity in a physical environment). In some embodiments, causing the characteristic of the first device to be adjusted in the first matter includes controlling (e.g., moving) a surface that covers (e.g., with respect to) an opening (e.g., a space and/or a void within the device). Adjusting an amount of space between a second portion of the first device and a reference surface when prescribed conditions are met allows the computer system to automatically change the openness between a particular device and a surface, thereby reducing the number of inputs needed to perform an operation and/or performing an operation when a set of conditions has been met without requiring further user input.

In some embodiments, in response to detecting the change in orientation of the light source (e.g., 912) relative to the respective object (e.g., as described above at FIG. 5B) and in accordance with a determination that the changed orientation of the light source relative to the respective object is the first orientation, the computer system causes the characteristic of the second device (e.g., 908 and/or 910) to be adjusted in a second manner that is opposite of the first manner (e.g., as described above in FIG. 5B). In some embodiments, in response to detecting the change in orientation of the light source relative to the respective object and in accordance with a determination that the changed orientation of the light source relative to the respective object is the second orientation, the computer system causes the characteristic of the first device to be adjusted in the second manner that is opposite of the first manner. Causing the characteristic of the second device to be adjusted in a second manner that is opposite of the first manner when prescribed conditions are met allows the computer system to automatically adjusts a characteristic of a particular device based on the orientation to the respective object in a manner that is different from the first manner, thereby reducing the number of inputs needed to perform an operation and/or performing an operation when a set of conditions has been met without requiring further user input.

In some embodiments, in response to detecting the change in orientation of the light source (e.g., 912) relative to the respective object (e.g., as described above at FIG. 5B) and in accordance with a determination that the changed orientation of the light source relative to the respective object is the first orientation, the computer system forgoes causing the characteristic of the second device (e.g., 908 and/or 910) to be adjusted (e.g., as described above at FIG. 5B). In some embodiments, in response to detecting the change in orientation of the light source relative to the respective object and in accordance with a determination that the changed orientation of the light source relative to the respective object is the second orientation, the computer system forgoes causing the characteristic of the first device to be adjusted. Not causing the characteristic of the second device to be adjusted in accordance with a determination that the changed orientation of the light source relative to the respective object is the first orientation allows the computer system to reframe from performing an operation that a user is likely to provide input to reverse performance of the operation, thereby reducing the number of inputs needed to perform an operation and/or performing an operation when a set of conditions has been met without requiring further user input.

In some embodiments, in response to detecting the change in orientation of the light source (e.g., 912) relative to the respective object (e.g., as described above at FIG. 5B) and in accordance with a determination that the changed orientation of the light source relative to the respective object is the first orientation, the computer system causes a second characteristic of the first device (e.g., 908 and/or 910) to be adjusted (and, in some examples, without causing a second characteristic of the second device to be adjusted), wherein the second characteristic of the first device is different from the characteristic of the first device. In some embodiments, in response to detecting the change in orientation of the light source relative to the respective object and in accordance with a determination that the changed orientation of the light source relative to the respective object is the second orientation, the computer system causes a second characteristic of the second device (e.g., 908 and/or 910) to be adjusted (and, In some embodiments, without causing the second characteristic of the first device to be adjusted), wherein the second characteristic of the second device is different from the characteristic of the second device. Causing a second characteristic of a particular device to be adjusted when prescribed conditions are met allows the computer system to automatically adjusts different characteristics of a particular device based on the orientation to the respective object, thereby reducing the number of inputs needed to perform an operation and/or performing an operation when a set of conditions has been met without requiring further user input.

In some embodiments, a value corresponding to the characteristic of the first device (e.g., 908 and/or 910) is set based on a first user-configurable setting (e.g., a temperature, fan, thermostat, window and/or door (e.g., window and/or door position and/or window and/or door tint), sound, light, and/or seat position setting). In some embodiments, a value corresponding to the characteristic of the second device (e.g., 908 and/or 910) is set based on a second user-configurable setting (e.g., a temperature, fan, thermostat, window and/or door (e.g., window and/or door position and/or window and/or door tint), sound, light, and/or seat position setting) that is different from the first user-configurable setting.

In some embodiments, in accordance with a determination that the first user-configurable setting indicates that the value is a first respective value, the characteristic of the first device (e.g., 908 and/or 910) is adjusted by a first amount in response to detecting the change in orientation of the light source (e.g., 912) relative to the respective object (e.g., as described above at FIG. 5B) and in accordance with a determination that the changed orientation of the light source relative to the respective object is the first orientation (e.g., as described above at FIG. 5A). In some embodiments, in accordance with a determination that the first user-configurable setting indicates that the value is a second respective value that is different from the first respective value, the characteristic of the first device is adjusted by a second amount that is different from the first amount in response to detecting the change in orientation of the light source relative to the respective object and in accordance with a determination that the changed orientation of the light source relative to the respective object is the first orientation (e.g., as described above at FIG. 5A). In some embodiments, the first device is adjusted differently based on the value of the user setting and the detected intensity of the light source. Adjusting the characteristic of the first device by different amounts based on the first user-configurable setting allows the computer system to adjust the characteristic of the first device by different amounts based on the preferences of the user, thereby reducing the number of inputs needed to perform an operation and/or performing an operation when a set of conditions has been met without requiring further user input.

In some embodiments, the first device (e.g., 908 and/or 910) has a surface (e.g., surface of a window, door, and/or component). In some embodiments, causing the characteristic of the first device to be adjusted in the first manner includes changing a second opacity of the surface (e.g., as described above at FIG. 5B). In some embodiments, in response to detecting the change in orientation of the light source (e.g., 912) relative to the respective object and in accordance with a determination that the changed orientation of the light source relative to the respective object is the first orientation (e.g., a light source, such as the sun, is near the surface and/or directed to the surface of the device), the computer system forgoes changing a positioning of the surface of the first device (e.g., as described above at FIG. 5B).

In some embodiments, in response to detecting the change in orientation of the light source (e.g., 912) relative to the respective object and in accordance with a determination that the changed orientation of the light source relative to the respective object is the first orientation, the computer system causes the characteristic of the second device (e.g., 908 and/or 910) to be adjusted in a third manner that is different from (and/or opposite of (e.g., increase vs decrease)) the first manner, wherein the second device is adjusted to a default value (e.g., a value set by a user, a minimum value, and/or a maximum value). Causing the characteristic of the second device to be adjusted in a third manner, where the second device is adjusted to a default value, when prescribed conditions are met allows the computer system to automatically adjust a particular device to a default value, thereby reducing the number of inputs needed to perform an operation and/or performing an operation when a set of conditions has been met without requiring further user input.

In some embodiments, the second device (e.g., 908 and/or 910) is gradually caused to be adjusted to the default value (e.g., as described above at FIG. 5B) (e.g., a value set by a user and/or a value that is derived from a user (e.g., a value determined based on determined preferences and/or preferences set by the user)).

In some embodiments, the computer system (e.g., 600) is in communication with a third device (e.g., 908 and/or 910) that is different from the first device (e.g., 908 and/or 910) and the second device (e.g., 908 and/or 910). In some embodiments, in response to detecting the change in orientation of the light source (e.g., 912) relative to the respective object and in accordance with a determination that the changed orientation of the light source relative to the respective object is the first orientation, the computer system causes a characteristic of the third device to be adjusted while causing the characteristic of the first device to be adjusted (e.g., as described above at FIG. 5B) (e.g., in the first manner, in the first manner and by a same amount that the first device is adjusted, and/or in the first manner and by a different amount that the first device is adjusted). In some embodiments, in response to detecting the change in orientation of the light source relative to the respective object and in accordance with a determination that the changed orientation of the light source relative to the respective object is the second orientation, the computer system causes the characteristic of the third device (or another device) to be adjusted while causing the characteristic of the second device to be adjusted. Causing a characteristic of the third device to be adjusted while causing the characteristic of the first device to be adjusted when prescribed conditions are met allows the computer system to concurrently and automatically adjust multiple devices based on prescribed condition, thereby reducing the number of inputs needed to perform an operation and/or performing an operation when a set of conditions has been met without requiring further user input.

In some embodiments, the third device (e.g., 908 and/or 910) is caused to be adjusted in a third manner that is different from the first manner (e.g., as described above at FIG. 5B). Causing a characteristic of the third device to be adjusted while causing the characteristic of the first device to be adjusted when prescribed conditions are met allows the computer system to adjust concurrently and automatically multiple devices in different manners based on prescribed condition, thereby reducing the number of inputs needed to perform an operation and/or performing an operation when a set of conditions has been met without requiring further user input.

In some embodiments, the third device (e.g., 908 and/or 910) is caused to be adjusted in the first manner (e.g., as described above at FIG. 5B). Causing a characteristic of the third device to be adjusted while causing the characteristic of the first device to be adjusted when prescribed conditions are met allows the computer system to adjust multiple devices concurrently and automatically in the same manner based on prescribed condition, thereby reducing the number of inputs needed to perform an operation and/or performing an operation when a set of conditions has been met without requiring further user input.

Note that details of the processes described above with respect to process 1000 (e.g., FIG. 6) are also applicable in an analogous manner to the methods described herein. For example, process 700 optionally includes one or more of the characteristics of the various methods described above with reference to process 1000. For example, a device can be adjusted based on the orientation of a light source using one or more techniques described above in relation to process 1000, where the amount that the device is adjusted is based on an offset using one or more techniques described above in relation to process 700. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a first device and a second device:
while the first device corresponds to a first area and the second device corresponds to a second area that is different from the first area, detecting a change in an orientation of a light source relative to a respective object; and
in response to detecting the change in orientation of the light source relative to the respective object:
in accordance with a determination that the changed orientation of the light source relative to the respective object is a first orientation, causing a characteristic of the first device to be adjusted in a first manner without causing the characteristic of the second device to be adjusted in the first manner; and
in accordance with a determination that the changed orientation of the light source relative to the respective object is a second orientation different from the first orientation, causing the characteristic of the second device to be adjusted in the first manner without causing the characteristic of the first device to be adjusted in the first manner.

2. The method of claim 1, wherein:
while in the first orientation, the light source impacts the first area more than the second area that is different from the second area; and
while in the second orientation, the light source impacts the second area more than the first area.

3. The method of claim 1, wherein causing the characteristic of the first device to be adjusted in the first manner includes adjusting a first opacity of a first portion of the first device.

4. The method of claim 1, wherein causing the characteristic of the first device to be adjusted in the first manner includes adjusting an amount of space between a second portion of the first device and a reference surface.

5. The method of claim 1, further comprising:
in response to detecting the change in orientation of the light source relative to the respective object:
in accordance with a determination that the changed orientation of the light source relative to the respective object is the first orientation, causing the characteristic of the second device to be adjusted in a second manner that is opposite of the first manner.

6. The method of claim 1, further comprising:
in response to detecting the change in orientation of the light source relative to the respective object:
in accordance with a determination that the changed orientation of the light source relative to the respective object is the first orientation, forgoing causing the characteristic of the second device to be adjusted.

7. The method of claim 1, further comprising:
in response to detecting the change in orientation of the light source relative to the respective object:
in accordance with a determination that the changed orientation of the light source relative to the respective object is the first orientation, causing a second characteristic of the first device to be adjusted, wherein the second characteristic of the first device is different from the characteristic of the first device; and
in accordance with a determination that the changed orientation of the light source relative to the respective object is the second orientation, causing a second characteristic of the second device to be adjusted, wherein the second characteristic of the second device is different from the characteristic of the second device.

8. The method of claim 1, wherein a value corresponding to the characteristic of the first device is set based on a first user-configurable setting, and wherein a value corresponding to the characteristic of the second device is set based on a second user-configurable setting that is different from the first user-configurable setting.

9. The method of claim 1, wherein:
in accordance with a determination that the first user-configurable setting indicates that the value is a first respective value, the characteristic of the first device is adjusted by a first amount in response to detecting the change in orientation of the light source relative to the respective object and in accordance with a determination that the changed orientation of the light source relative to the respective object is the first orientation; and
in accordance with a determination that the first user-configurable setting indicates that the value is a second respective value that is different from the first respective value, the characteristic of the first device is adjusted by a second amount that is different from the first amount in response to detecting the change in orientation of the light source relative to the respective object and in accordance with a determination that the changed orientation of the light source relative to the respective object is the first orientation.

10. The method of claim 1, wherein:
the first device has a surface;
causing the characteristic of the first device to be adjusted in the first manner includes changing a second opacity of the surface; and
the method further comprises:
in response to detecting the change in orientation of the light source relative to the respective object and in accordance with a determination that the changed orientation of the light source relative to the respective object is the first orientation, forgoing changing a positioning of the surface of the first device.

11. The method of claim 1, further comprising:
in response to detecting the change in orientation of the light source relative to the respective object and in accordance with a determination that the changed orientation of the light source relative to the respective object is the first orientation, causing the characteristic of the second device to be adjusted in a third manner that is different from the first manner, wherein the second device is adjusted to a default value.

12. The method of claim 11, wherein the second device is gradually caused to be adjusted to the default value.

13. The method of claim 1, wherein the computer system is in communication with a third device that is different from the first device and the second device, the method further comprising:
in response to detecting the change in orientation of the light source relative to the respective object and in accordance with a determination that the changed orientation of the light source relative to the respective object is the first orientation, causing a characteristic of the third device to be adjusted while causing the characteristic of the first device to be adjusted.

14. The method of claim 13, wherein the third device is caused to be adjusted in a third manner that is different from the first manner.

15. The method of claim 13, wherein the third device is caused to be adjusted in the first manner.

16. A non-transitory computer-readable storage medium storing one or more programs configured to be executed by one or more processors of a computer system that is in communication with a first device and a second device, the one or more programs including instructions for:
while the first device corresponds to a first area and the second device corresponds to a second area that is different from the first area, detecting a change in an orientation of a light source relative to a respective object; and
in response to detecting the change in orientation of the light source relative to the respective object:
in accordance with a determination that the changed orientation of the light source relative to the respective object is a first orientation, causing a characteristic of the first device to be adjusted in a first manner without causing the characteristic of the second device to be adjusted in the first manner; and
in accordance with a determination that the changed orientation of the light source relative to the respective object is a second orientation different from the first orientation, causing the characteristic of the second device to be adjusted in the first manner without causing the characteristic of the first device to be adjusted in the first manner.

17. A computer system that is in communication with a first device and a second device, comprising:
one or more processors; and
memory storing one or more programs configured to be executed by the one or more processors, the one or more programs including instructions for:
while the first device corresponds to a first area and the second device corresponds to a second area that is different from the first area, detecting a change in an orientation of a light source relative to a respective object; and
in response to detecting the change in orientation of the light source relative to the respective object:
in accordance with a determination that the changed orientation of the light source relative to the respective object is a first orientation, causing a characteristic of the first device to be adjusted in a first manner without causing the characteristic of the second device to be adjusted in the first manner; and
in accordance with a determination that the changed orientation of the light source relative to the respective object is a second orientation different from the first orientation, causing the characteristic of the second device to be adjusted in the first manner without causing the characteristic of the first device to be adjusted in the first manner.
